(19) United States
(12) Patent Application Publication
(10) Pub. No.: US 2006/0053116 A1
(43) Pub. Date: Mar. 9, 2006

(54) Dynamic software updating using mobile agent AOP

(76) Inventors: Maarten E. Rits, Sophia Antipolis (FR); Cedric S.P. Ulmer, Nice (FR); Cedric R.J. Hebert, Mouans-Sartoux (FR); Pascal T.C. Spadone, Antibes (FR); Laurent Y. Gomez, Le Cannet (FR)

Correspondence Address: PERKINS COIE LLP, P.O. BOX 2168, MENLO PARK, CA, 94026, US

(21) Appl. No.: 10/931,717

(22) Filed: Aug. 31, 2004

(51) Int. Cl. G06F 17/30

(52) U.S. Cl. 707/10

(57) ABSTRACT

A system for dynamic software updating using a mobile agent includes a server for issuing the mobile agent with a software update and a client for receiving the mobile agent. The mobile agent executes the software update, on the client, utilizing aspect oriented programming.

### FIELD OF THE INVENTION

The present invention relates to software updating and more particularly to dynamic software updating.

### BACKGROUND OF THE INVENTION

In a traditional client-server architecture, software updates are typically accomplished by scheduling the update to the client upon startup. This method works well for non-critical updates but has several disadvantages if the update is critical. Typically, the software update can only be sent, from a server to a client, upon startup and very often requires a reboot to complete the update. This can be very disruptive in the middle of a workday and especially so in environments that require long term preservation of a system state. Additionally, a large number of clients contemporaneously trying to complete an update will often place a large load on a server that can in turn precipitate server failure.

An improvement of the aforementioned method of software updating is the use of a mobile agent. A mobile agent is a program that performs some information gathering or processing task in the background. Typically, the mobile agent is given a very small and well-defined task. FIG. 1 is a block diagram of a prior art client-server architecture 10 that utilizes a mobile agent A to accomplish a software update. Included in architecture 10 are servers 20, 30 and various clients 40, 50 and 60. The clients 20 and 30 and the servers 40, 50 and 60 are all b-directionally coupled via network connection 70. In practice, a server, such as server 20, will send out the mobile agent A to perform a software update to a number of clients. Agent A first travels to client 40 and performs the update. Agent A then travels to clients 50 and 60 and performs the update there, as well. Once all the updates are completed, agent A goes back to server 20.

Architecture 10, utilizing mobile agent A, efficiently performs software updates that do not require time-intensive reboots. However, architecture 10 still has shortcomings. Mobile agent A typically is not flexible—once it is created and sent to a server, agent A is not easily modified. Additionally, agent A typically also cannot be recalled once it is sent out.

As a result of the above situation, there is a need for methods and systems to efficiently effect software updates, preferably with a mobile agent, yet allow for that mobile agent to evolve as necessary. It would also be useful to have an ability to recall the mobile agent, if desired.

### SUMMARY OF THE INVENTION

The present invention is described and illustrated in conjunction with systems, apparatuses and methods of varying scope. In addition to the aspects of the present invention described in this summary, further aspects of the invention will become apparent by reference to the drawings and by reading the detailed description that follows.

A system for dynamic software updating using a mobile agent, in accordance with an embodiment of the present invention, includes a server for issuing the mobile agent with a software update and a client for receiving the mobile agent. The mobile agent executes the software update, on the client, utilizing aspect oriented programming.

A method for dynamic software updating using a mobile agent, in accordance with another embodiment of the present invention, includes sending the mobile agent that has a software update from a server to a client. The software update is then executed at the client by the mobile agent wherein the mobile agent executes the software update utilizing aspect oriented programming.

A method for creating a mobile agent, in accordance with yet another embodiment of the present invention, includes receiving one or more aspects, an installation instruction and an application list. A client list is then created from a master client list for an application in the application list and the mobile agent is created based on the one or more aspects, the installation instruction and the client list.

Embodiments of the invention presented are exemplary and illustrative in nature, rather than restrictive. The scope of the invention is determined by the appended claims.

### BRIEF DESCRIPTION OF THE DRAWINGS

FIG. 1 is a block diagram of a prior art client-server architecture 10 that utilizes a mobile agent A to accomplish a software update;

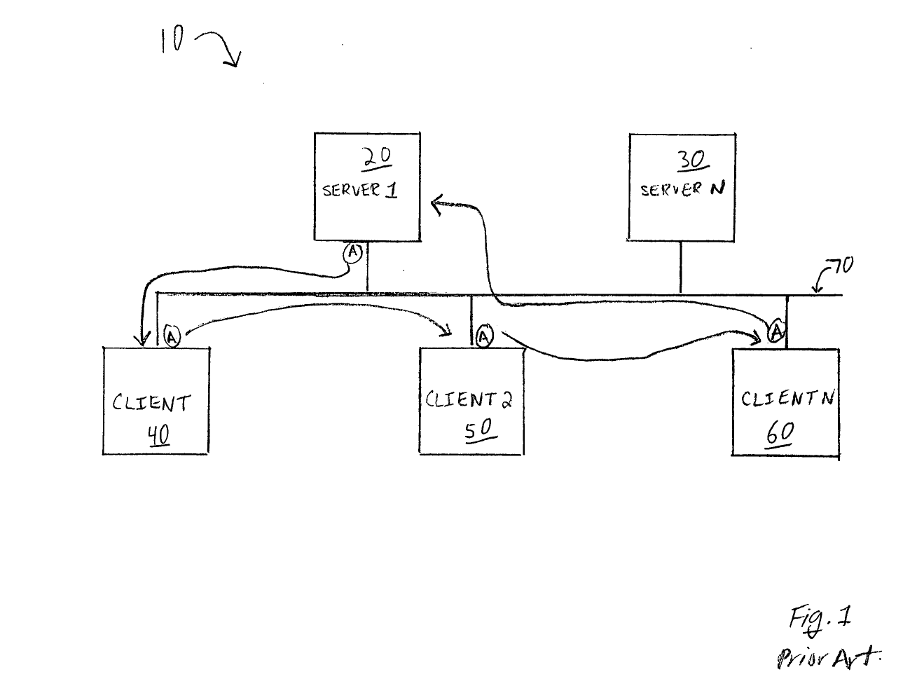

FIG. 2 is a block diagram illustrating a mobile agent with aspects, in accordance with the present invention;

FIG. 3 illustrates a server-side process of creating a mobile agent, in accordance with the present invention;

FIG. 4 is a flowchart illustrating a process for creating a mobile agent from an update, in accordance with the present invention;

FIG. 5 illustrates an exemplary mobile agent pseudo-code, in accordance with the present invention;

FIG. 6 illustrates a client-side process of a mobile agent executing an update, in accordance with the present invention;

FIG. 7 is a block diagram of an embodiment of a network; and

FIG. 8 is a block diagram of an embodiment of a computer.

### DETAILED DESCRIPTION OF THE INVENTION

The present invention contemplates a variety of methods and systems for providing dynamic software updating via mobile agents through the use of aspect-oriented programming (“AOP”). AOP is a programming technique that allows programmers to modularize crosscutting concerns (behavior that cuts across the typical divisions of responsibility, such as logging). AOP introduces aspects, which encapsulate behaviors that affect multiple classes into reusable modules. As a result, AOP encoded mobile agents are more flexible than prior art mobile agents.

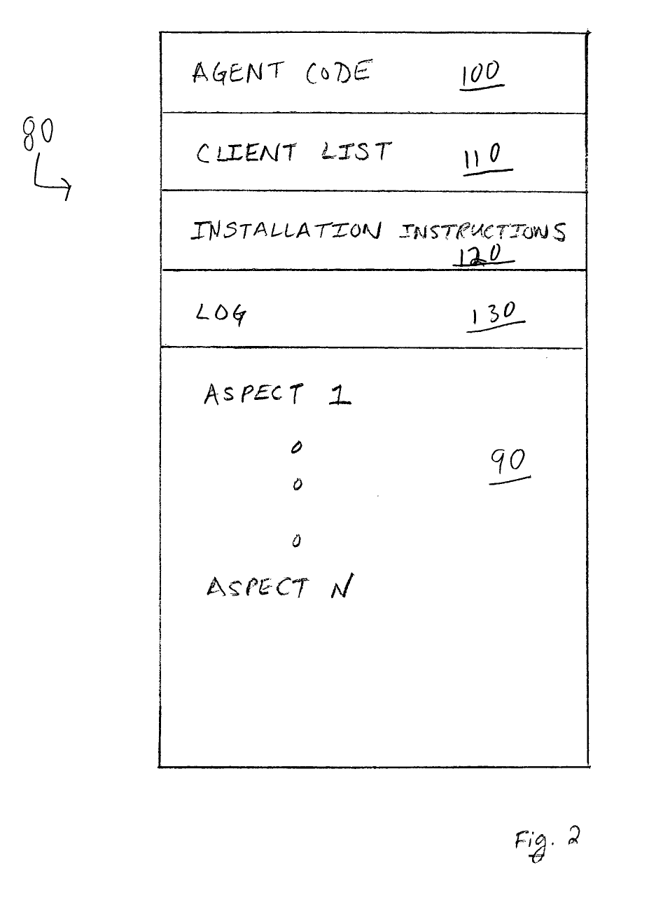

An example AOP encoded mobile agent can be seen in FIG. 2 which is a block diagram illustrating a mobile agent 80 with aspects 90, in accordance with the present invention. Besides the aspects 90, agent code 100, client list 110, installation instructions 120 and a log 130 are also included. Agent code 100 includes various operating instructions that determine the functionality of the mobile agent and will be detailed subsequently. Client list 110 contains an identification of all clients that require a software update. Client list 110 is necessary as all clients on a network may not contain the same software packages. As a result, a particular software update is obviously not necessary for a client that does not have the corresponding installed software.

Installation instructions 120 contain the information regarding what software to update and the actual software update. Log 130 is utilized to record the various operations of mobile agent 80. These operations can include a list of clients as they get updates, a list of unavailable clients and other related information. Finally, aspects 90 can be utilized to modify agent 80 after it is initially built.

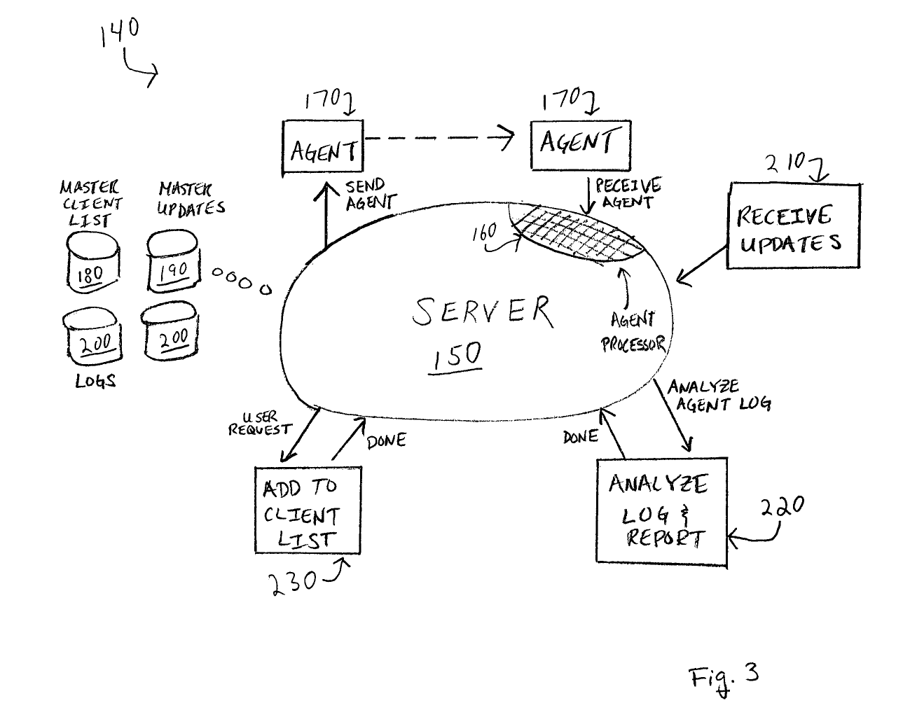

The process of how a mobile agent is created by a server will now be discussed with reference to FIG. 3 that illustrates a server-side process 140 of creating a mobile agent, in accordance with the present invention. Included in process 140 is a server 150 that contains an agent processor 160. Also included is a mobile agent 170, master client list 180, master updates 190 and logs 200.

In practice, the server 150 receives an update 210 and then builds an agent 170 utilizing the agent processor 160 and the master client list 180. Agent 170 is then sent out to perform the update at the clients (not shown) and can optionally be received back at the agent processor 160, after the updates have been completed. Once complete, logs 200 can be removed from the agent 170 and analyzed at module 220. Server 150 can also process user request 230 to add a client to the master client list 180.

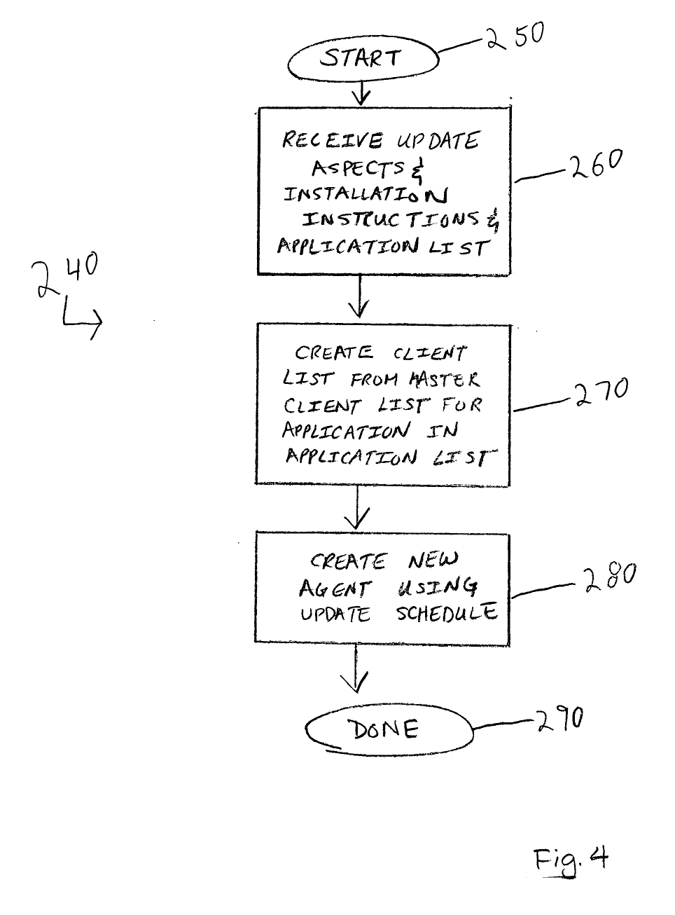

The actual process of creating the mobile agent 170 will now be detailed with reference to FIG. 4. that shows a flowchart illustrating a process 240 for creating a mobile agent 170 from an update 210, in accordance with the present invention. After a start operation 250, update aspects, installation instructions and an application list are received at operation 260. A client list is the created from a master client list for an application in an application list, at operation 270. A new agent is then created based on the aspects, installation instructions and client list according to an update schedule at operation 280. Process 240 is then completed at operation 290.

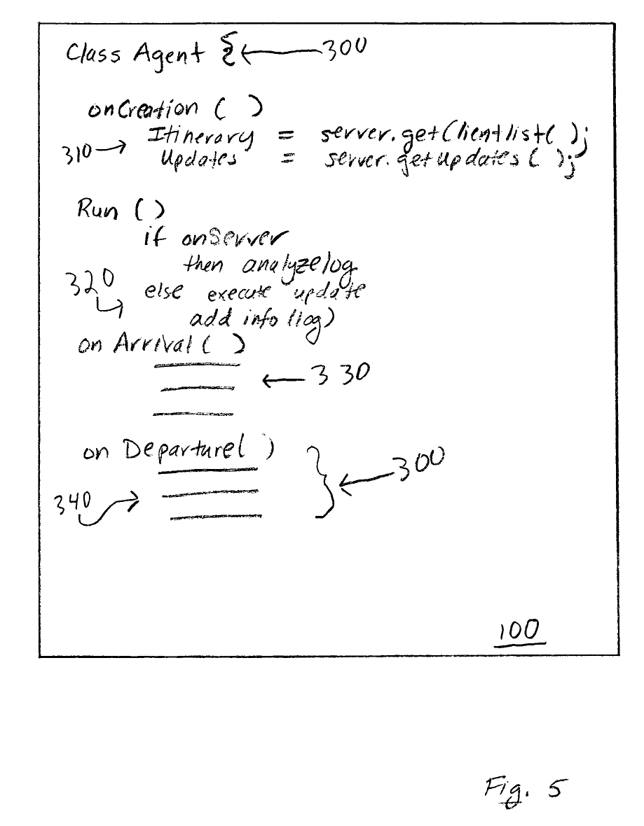

The agent code 100 of FIG. 2 will now be described in detail. FIG. 5 illustrates an exemplary mobile agent pseudo-code 100, in accordance with the present invention. Included in code 100 are class agent brackets 300 that signify the beginning and end of code 100. Inside brackets 300 includes various sections such as an onCreation section 310. Once an agent is created, this section would be executed. The run section 320 contains various instructions to execute, dependent on where the agent is located. For example, if the agent is at the server then a certain set of instructions would be executed. If elsewhere, a different set of instructions could be executed, such as an update. Additional instructions can include an arrival set of instructions 330 for execution upon arriving at a client. Similarly, departure instructions 340 can also be included that are executed when a mobile agent leaves a client.

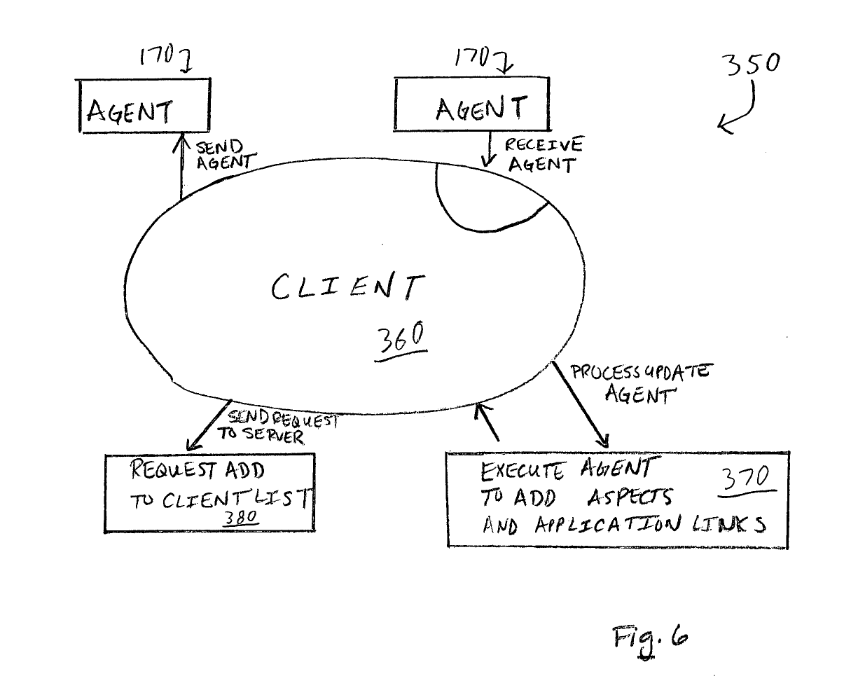

The interaction of a mobile agent and client will now be detailed. FIG. 6 illustrates a client-side process 350 of a mobile agent 170 executing an update, in accordance with the present invention. Agent 170 arrives at client 360 and in turn the agent is executed, at module 370, wherein aspects and application links are added to client 360. Once the update is complete, the mobile agent 170 is sent on to the next client requiring the update or perhaps to the server (not shown) that issued the agent 170. One skilled in the art will recognize that it is not a requirement of the present invention for the mobile agent to return to the server once all the clients have been updated. In addition, a client can also send a request 380 to a server to be added to the client list.

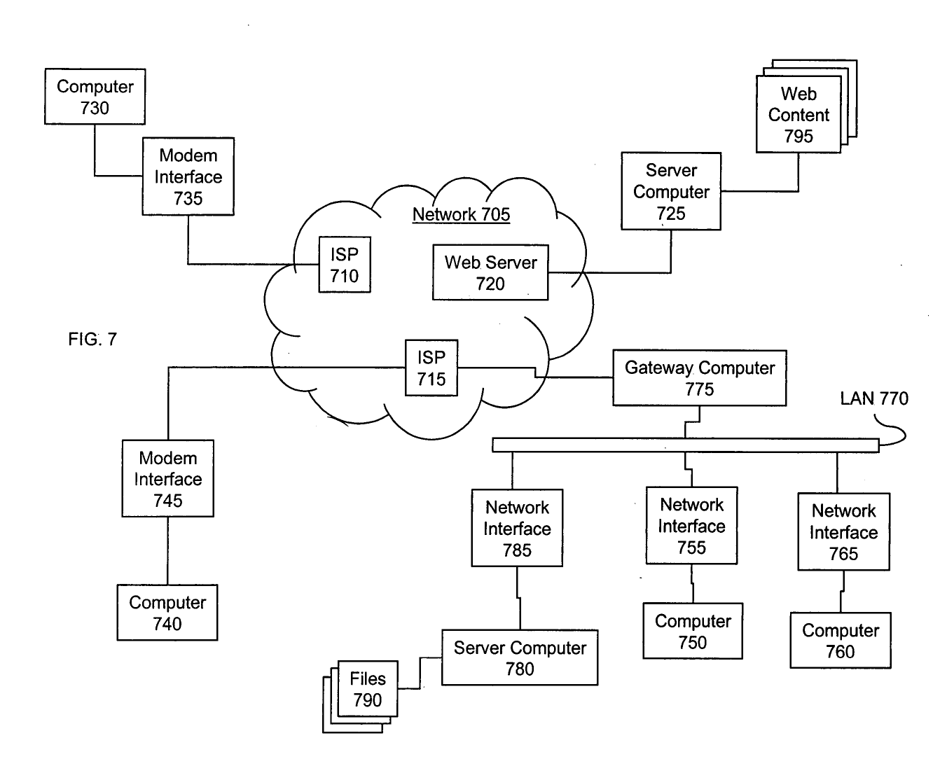

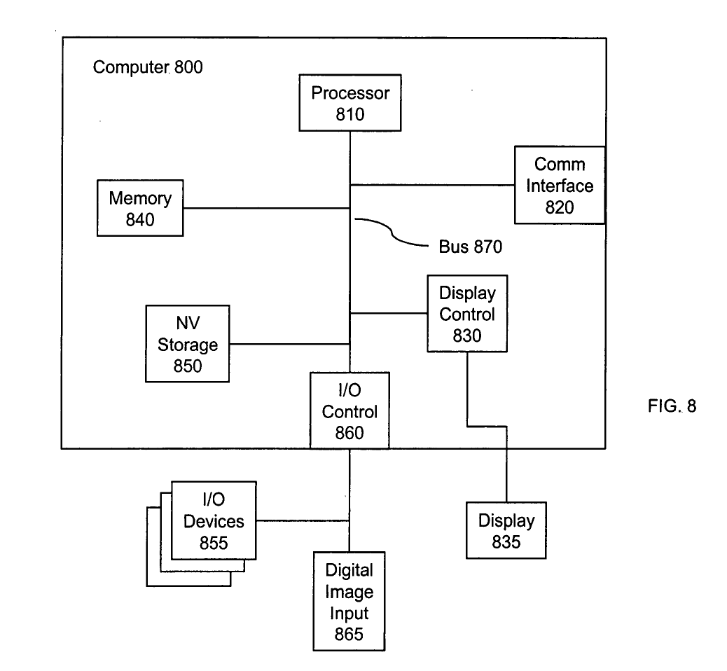

The following description of FIGS. 7-8 is intended to provide an overview of computer hardware and other operating components suitable for performing the methods of the invention described above, but is not intended to limit the applicable environments. Similarly, the computer hardware and other operating components may be suitable as part of the apparatuses of the invention described above. The invention can be practiced with other computer system configurations, including hand-held devices, multiprocessor systems, microprocessor-based or programmable consumer electronics, network PCs, minicomputers, mainframe computers, and the like. The invention can also be practiced in distributed computing environments where tasks are performed by remote processing devices that are linked through a communications network.

FIG. 7 is a block diagram of an embodiment of a network 705, such as the Internet. The term “Internet” as used herein refers to a network of networks which uses certain protocols, such as the TCP/IP protocol, and possibly other protocols such as the hypertext transfer protocol (HTTP) for hypertext markup language (HTML) documents that make up the World Wide Web (web). The physical connections of the Internet and the protocols and communication procedures of the Internet are well known to those of skill in the art.

Access to the Internet 705 is typically provided by Internet service providers (ISP), such as the ISPs 710 and 715. Users on client systems, such as client computer systems 730, 740, 750, and 760 obtain access to the Internet through the Internet service providers, such as ISPs 710 and 715. Access to the Internet allows users of the client computer systems to exchange information, receive and send e-mails, and view documents, such as documents which have been prepared in the HTML format. These documents are often provided by web servers, such as web server 720 which is considered to be “on” the Internet. Often these web servers are provided by the ISPs, such as ISP 710, although a computer system can be set up and connected to the Internet without that system also being an ISP.

The web server 720 is typically at least one computer system which operates as a server computer system and is configured to operate with the protocols of the World Wide Web and is coupled to the Internet. Optionally, the web server 720 can be part of an ISP which provides access to the Internet for client systems. The web server 720 is shown coupled to the server computer system 725 which itself is coupled to web content 795, which can be considered a form of a media database. While two computer systems 720 and 725 are shown in FIG. 8, the web server system 720 and the server computer system 725 can be one computer system having different software components providing the web server functionality and the server functionality provided by the server computer system 725 which will be described further below.

Client computer systems 730, 740, 750, and 760 can each, with the appropriate web browsing software, view HTML pages provided by the web server 720. The ISP 710 provides Internet connectivity to the client computer system 730 through the modem interface 735 which can be considered part of the client computer system 730. The client computer system can be a personal computer system, a network computer, a Web TV system, or other such computer system.

Similarly, the ISP 715 provides Internet connectivity for client systems 740, 750, and 760, although as shown in FIG. 7, the connections are not the same for these three computer systems. Client computer system 740 is coupled through a modem interface 745 while client computer systems 750 and 760 are part of a LAN. While FIG. 7 shows the interfaces 735 and 745 as generically as a “modem,” each of these interfaces can be an analog modem, ISDN modem, cable modem, satellite transmission interface (e.g. “Direct PC”), or other interfaces for coupling a computer system to other computer systems.

Client computer systems 750 and 760 are coupled to a LAN 770 through network interfaces 755 and 765, which can be Ethernet network or other network interfaces. The LAN 770 is also coupled to a gateway computer system 775 that can provide firewall and other Internet related services for the local area network. This gateway computer system 775 is coupled to the ISP 715 to provide Internet connectivity to the client computer systems 750 and 760. The gateway computer system 775 can be a conventional server computer system. Also, the web server system 720 can be a conventional server computer system.

Alternatively, a server computer system 780 can be directly coupled to the LAN 770 through a network interface 785 to provide files 790 and other services to the clients 750, 760, without the need to connect to the Internet through the gateway system 775.

FIG. 8 is a block diagram of an embodiment of a computer that can be used as a client computer system or a server computer system or as a web server system. Such a computer system can be used to perform many of the functions of an Internet service provider, such as ISP 710. The computer system 800 interfaces to external systems through the modem or network interface 820. It will be appreciated that the modem or network interface 820 can be considered to be part of the computer system 800. This interface 820 can be an analog modem, ISDN modem, cable modem, token ring interface, satellite transmission interface (e.g. “Direct PC”), or other interfaces for coupling a computer system to other computer systems.

The computer system 800 includes a processor 810, which can be a conventional microprocessor such as an Intel Pentium microprocessor or Motorola Power PC microprocessor. Memory 840 is coupled to the processor 810 by a bus 870. Memory 840 can be dynamic random access memory (DRAM) and can also include static RAM (SRAM). The bus 870 couples the processor 810 to the memory 840, also to non-volatile storage 850, to display controller 830, and to the input/output (I/O) controller 860.

The display controller 830 controls in the conventional manner a display on a display device 835 which can be a cathode ray tube (CRT) or liquid crystal display (LCD). The input/output devices 855 can include a keyboard, disk drives, printers, a scanner, and other input and output devices, including a mouse or other pointing device. The display controller 830 and the I/O controller 860 can be implemented with conventional well-known technology. A digital image input device 865 can be a digital camera which is coupled to an I/O controller 860 in order to allow images from the digital camera to be input into the computer system 800.

The non-volatile storage 850 is often a magnetic hard disk, an optical disk, or another form of storage for large amounts of data. Some of this data is often written, by a direct memory access process, into memory 840 during execution of software in the computer system 800. One of skill in the art will immediately recognize that the terms “machine-readable medium” or “computer-readable medium” includes any type of storage device that is accessible by the processor 810 and also encompasses a carrier wave that encodes a data signal.

The computer system 800 is one example of many possible computer systems which have different architectures. For example, personal computers based on an Intel microprocessor often have multiple buses, one of which can be an input/output (I/O) bus for the peripherals and one that directly connects the processor 810 and the memory 840 (often referred to as a memory bus). The buses are connected together through bridge components that perform any necessary translation due to differing bus protocols.

Network computers are another type of computer system that can be used with the present invention. Network computers do not usually include a hard disk or other mass storage, and the executable programs are loaded from a network connection into the memory 840 for execution by the processor 810. A Web TV system, which is known in the art, is also considered to be a computer system according to this embodiment, but it may lack some of the features shown in FIG. 8, such as certain input or output devices. A typical computer system will usually include at least a processor, memory, and a bus coupling the memory to the processor.

In addition, the computer system 800 is controlled by operating system software which includes a file management system, such as a disk operating system, which is part of the operating system software. One example of an operating system software with its associated file management system software is the family of operating systems known as Windows® from Microsoft Corporation of Redmond, Wash., and their associated file management systems. Another example of an operating system software with its associated file management system software is the LINUX operating system and its associated file management system. The file management system is typically stored in the non-volatile storage 850 and causes the processor 810 to execute the various acts required by the operating system to input and output data and to store data in memory, including storing files on the non-volatile storage 850.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Some embodiments also relate to apparatus for performing the operations herein. This apparatus may be specially constructed for the required purposes, or it may comprise a general-purpose computer selectively activated or reconfigured by a computer program stored in the computer. Such a computer program may be stored (embodied) in a computer (machine) readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language, and various embodiments may thus be implemented using a variety of programming languages.

This invention potentially allows for dynamic software updating via mobile agents that is more flexible than prior art methods and systems. Since the mobile agent can be changed on the fly via aspect-oriented programming, more efficient and robust software updates can be potentially achieved.

While this invention has been described in terms of certain embodiments, it will be appreciated by those skilled in the art that certain modifications, permutations and equivalents thereof are within the inventive scope of the present invention. It is therefore intended that the following appended claims include all such modifications, permutations and equivalents as fall within the true spirit and scope of the present invention

What is claimed is:

1. A system for dynamic software updating using a mobile agent comprising:
a server for issuing the mobile agent with a software update; and
a client for receiving the mobile agent wherein the mobile agent executes the software update, on the client, utilizing aspect oriented programming.

2. The system as recited in claim 1 wherein the server receives the mobile agent after the software update is executed.

3. The system as recited in claim 1 wherein the mobile agent executes the software update on a plurality of clients in a serial fashion.

4. The system as recited in claim 1 wherein the mobile agent is a plurality of mobile agents each with a copy of the software update and the client is a plurality of clients wherein each mobile agent of the plurality of mobile agents executes their copy of the software update on a different client of the plurality of clients.

5. The system as recited in claim 1 wherein the server further comprises an agent processor that builds, sends out and receives the mobile agent.

6. The system as recited in claim 1 wherein the mobile agent comprises an agent code, a client list, installation instructions, a log file and one or more aspects.

7. A method for dynamic software updating using a mobile agent comprising:
sending the mobile agent that has a software update from a server to a client; and
executing the software update at the client by the mobile agent wherein the mobile agent executes the software update utilizing aspect oriented programming.

8. The method as recited in claim 7 wherein the server receives the mobile agent after the software update is executed.

9. The system as recited in claim 7 wherein the mobile agent executes the software update on a plurality of clients in a serial fashion.

10. The system as recited in claim 7 wherein the mobile agent is a plurality of mobile agents each with a copy of the software update and the client is a plurality of clients wherein each mobile agent of the plurality of mobile agents executes their copy of the software update on a different client of the plurality of clients.

11. The system as recited in claim 7 wherein the server further comprises an agent processor that builds, sends out and receives the mobile agent.

12. The system as recited in claim 7 wherein the mobile agent comprises an agent code, a client list, installation instructions, a log file and one or more aspects.

13. A method for creating a mobile agent comprising:
receiving one or more aspects, an installation instruction and an application list;
creating a client list from a master client list for an application in the application list; and
creating the mobile agent based on the one or more aspects, the installation instruction and the client list.

14. A mobile agent data structure for use in dynamic software updating comprising an agent code, a client list, an installation instructions, a log and one or more aspects.
